(19) United States
(12) Patent Application Publication
(10) Pub. No.: US 2006/0095408 A1
(43) Pub. Date: May 4, 2006

(54) Predictive routing engine for business processes

(76) Inventor: Paul M. Tabet, Danville, CA (US)

Correspondence Address: MORRISON & FOERSTER LLP, 425 MARKET STREET, SAN FRANCISCO, CA, 94105-2482, US

(21) Appl. No.: 10/980,128

(22) Filed: Nov. 1, 2004

(51) Int. Cl. G06F 17/30

(52) U.S. Cl. 707/3

(57) ABSTRACT

A process path is predicted for a business process involving participants within an enterprise and/or across enterprises by receiving a form containing content provided by an initiator of a current iteration of the business process. One or more key data are selected from the content in the received form. The one or more selected key data are compared to the content of one or more previous iterations of the business process that have been stored, each of the one or more previous iterations of the business process being associated with a process path. A closest matching previous iteration of the business process is determined based on the comparison. A predicted process path for the current iteration of the business process provided by the initiator is identified, the predicted process path is the process path associated with the closest matching previous iteration of the business process.

### BACKGROUND

1. Field

The present application generally relates to automating business processes, and, in particular, to predicting a process path for a business process involving participants within an enterprise and/or across enterprises.

2. Related Art

Despite the widespread adoption of enterprise software designed to automate business processes, companies still rely heavily on manual processes. One shortcoming of enterprise software and other business process automation software has been the amount of time and effort needed to analyze, design, and implement the automation process. Additionally, once it is implemented, considerable time and effort may be needed to implement any changes.

For example, to automate a business process using conventional enterprise software or business process automation software, considerable time and effort is spent in analyzing the business process. Additionally, because those who implement the automation, such as software engineers and programmers, are not familiar with the business process, training may be required even before the automation process can begin. A model of the business process is then typically generated based on an analysis of the business process. Codes are then generated, which typically involve conditional statements, such as if-then statements. Testing is performed, and finally the automated process is launched. If a change in the business process occurs, then the codes may need to be modified, which can result in downtime and additional expense.

### SUMMARY

In one exemplary embodiment, a process path is predicted for a business process involving participants within an enterprise and/or across enterprises by receiving a form containing content provided by an initiator of a current iteration of the business process. One or more key data are selected from the content in the received form. The one or more selected key data are compared to the content of one or more previous iterations of the business process that have been stored, each of the one or more previous iterations of the business process being associated with a process path. A closest matching previous iteration of the business process is determined based on the comparison. A predicted process path for the current iteration of the business process provided by the initiator is identified, the predicted process path is the process path associated with the closest matching previous iteration of the business process.

### BRIEF DESCRIPTION OF THE DRAWINGS

FIG. 1 is a flowchart depicting an exemplary automated process to predict a process path for a business process;

FIG. 2 depicts an exemplary list of exemplary forms;

FIG. 3 is a block diagram of an exemplary system to predict a process path for a business process;

FIG. 4 depicts an exemplary form;

FIG. 5 depicts an exemplary set of policies;

FIG. 6 depicts an exemplary form after being validated using the exemplary set of policies depicted in FIG. 5;

FIG. 7 depicts an exemplary process path; and

FIG. 8 depicts an exemplary window that can be used to modify the exemplary path depicted in FIG. 7.

### DETAILED DESCRIPTION

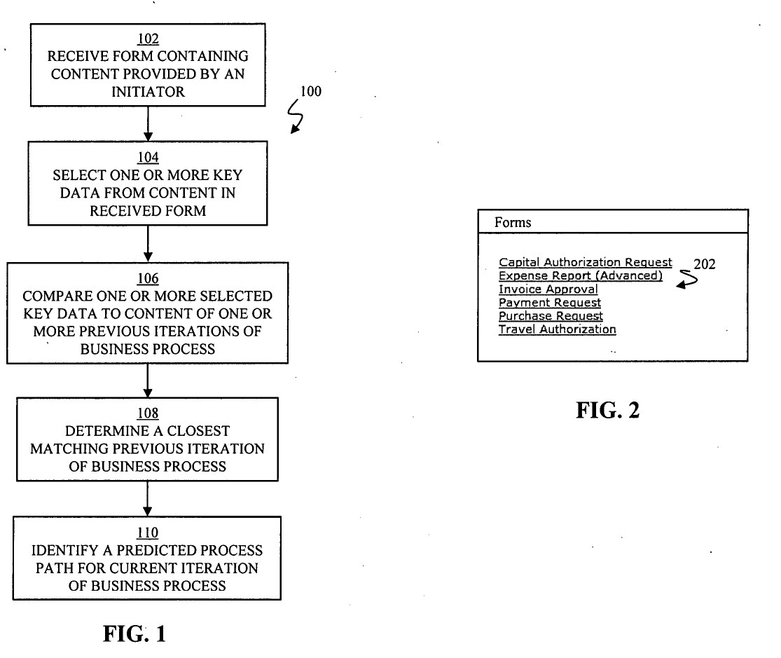

With reference to FIG. 1, an exemplary automated process 100 is depicted for predicting a process path for a business process involving participants within an enterprise and/or across enterprises. It should be noted that exemplary process 100 can be implemented in software, hardware, or a combination of software and hardware.

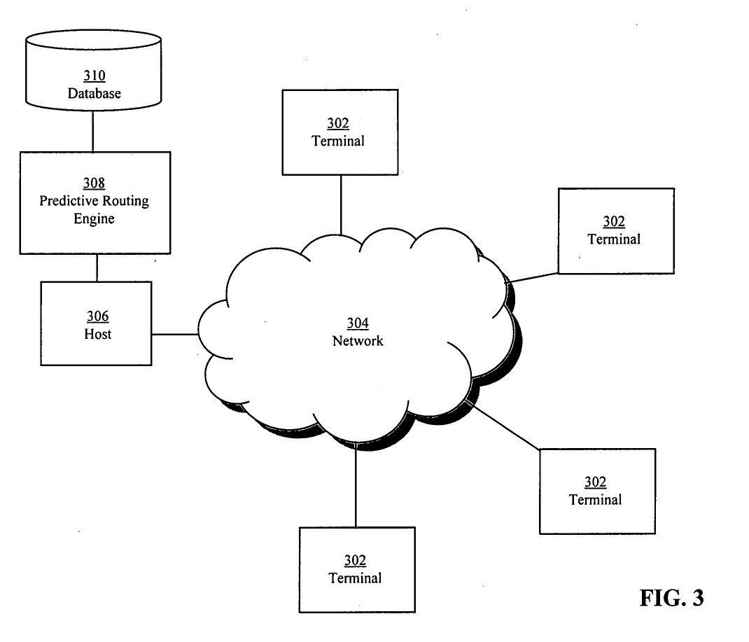

With reference to FIG. 2, in one exemplary embodiment, an initiator can select a form from a form list 202 corresponding to different types of business processes to initiate a current iteration of a business process. As depicted in FIG. 2, a form list 202 includes forms for “Capital Authorization Request”, “Expense Report”, “Invoice Approval”, “Payment Request”, “Purchase Request”, and “Travel Authorization.” It should be noted that list 202 of exemplary forms depicted in FIG. 2 is not meant to be exhaustive, and that various different types of forms can be provided for various types of business processes to be automated.

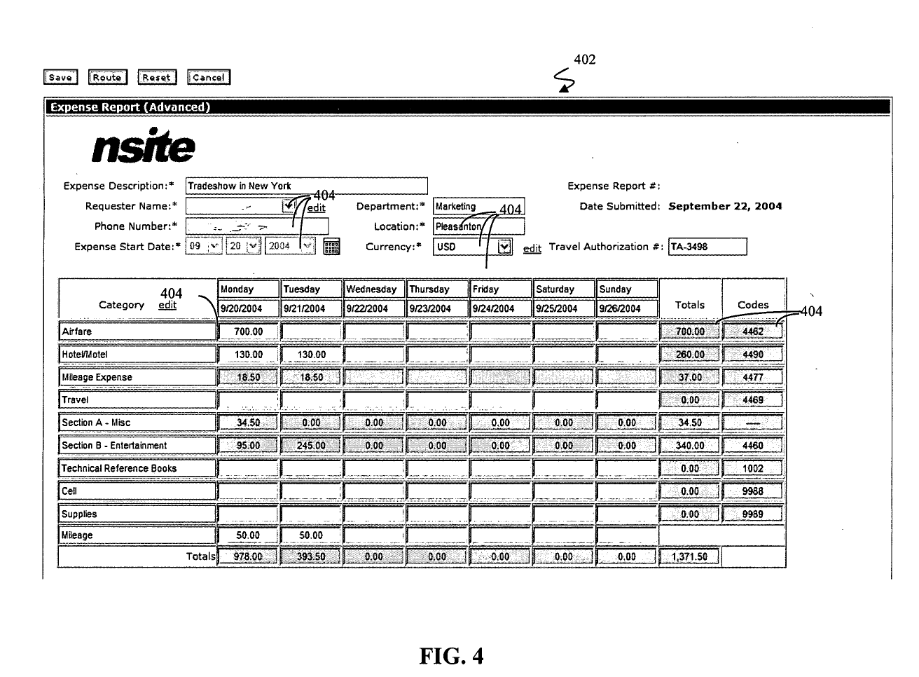

With reference to FIG. 3, the initiator can access form list 202 (FIG. 2) from terminal 302. In particular, in the present exemplary embodiment, form list 202 (FIG. 2) is maintained by host 306, which provides access to form list 202 (FIG. 2) through a computer network 304. Terminal 302 can include various types of computer devices capable of displaying information and receiving instructions from a user, such as a desktop computer, a laptop computer, a tablet device, a personal data device, a Web-enabled mobile phone, and the like. Host 306 can also include various types of computer devices capable of processing and responding to requests from terminal 302, such as a server, a mainframe, and the like. Network 304 can include various types and combinations of types of communication media, such as a local area network, a wide area network, a wireless local area network, the Internet, and the like.

In one preferred embodiment, host 306 is implemented on a Web server, and terminal 302 accesses a form through the Internet using a Web browser. Exemplary process 100 (FIG. 1) is performed by host 306 and/or predictive routing engine (PRE) 308, which will be described in more detail below. Thus, in this embodiment, no specialized software or hardware is required at terminal 302.

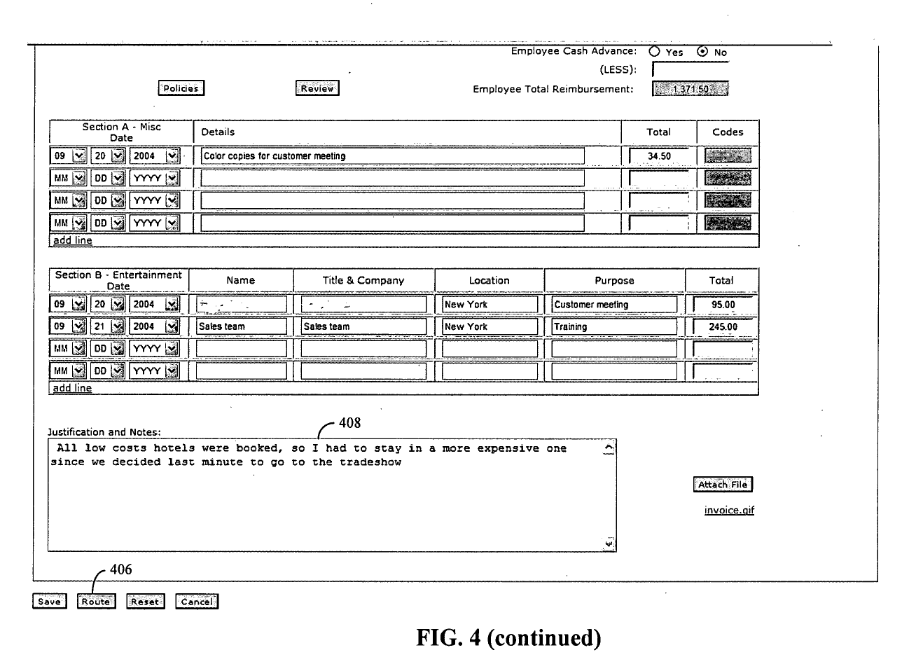

With reference to FIG. 2, when the initiator selects from form list 202, the form is then displayed to the initiator. For the sake of example, assume that the initiator selects the “Expense Report” form from form list 202. With reference to FIG. 4, an exemplary “Expense Report” form 402 is depicted. Exemplary form 402 includes a plurality of fields 404 for the initiator to enter data. For example, exemplary form 402 depicted in FIG. 4 includes fields 404 for “Expense Description,” “Requester Name,” “Phone Number,” etc. The data entered into fields 404 in exemplary form 402 are also referred to herein as the content of form 402.

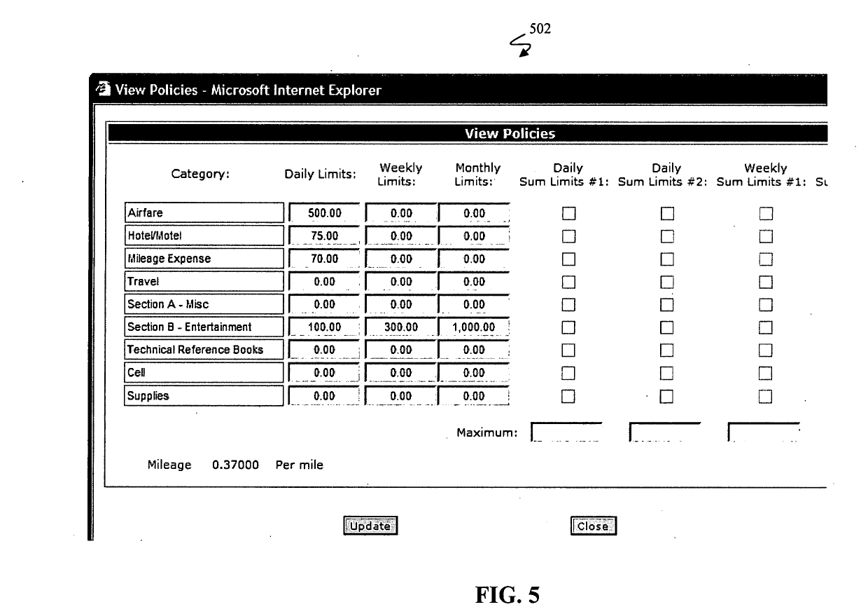

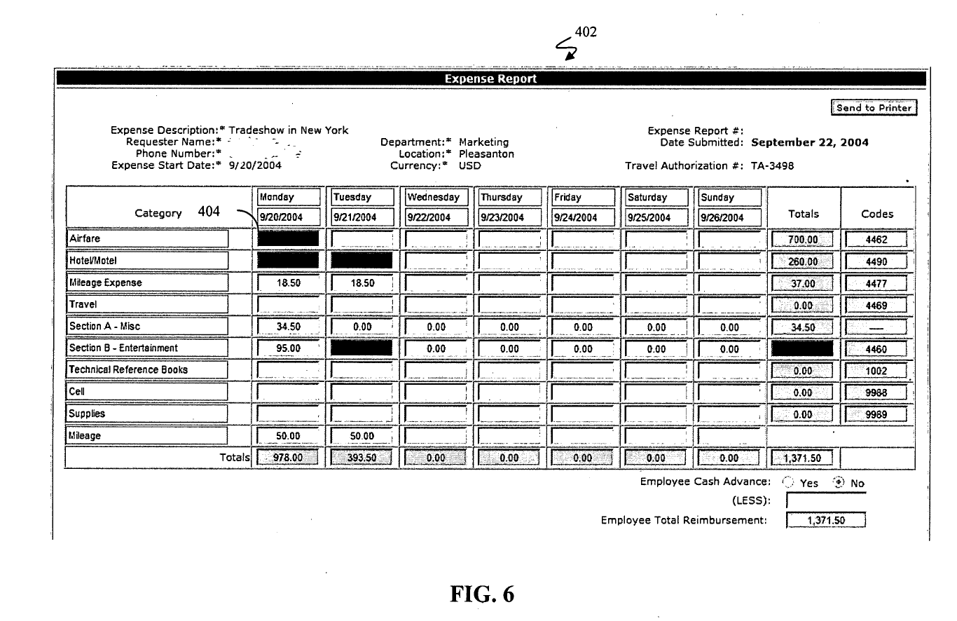

After the initiator has completed entering data into fields 404 of form 402, the initiator can select a “Route” button 406 to route form 402. In the present exemplary embodiment, before form 402 is routed, the content of form 402 is validated. In particular, with reference to FIG. 5, a set of policies 502 can be specified to validate the content of form 402 (FIG. 4). For example, as depicted in FIG. 5, a daily limit of $500.00 can be set as a policy for the “Airfare” field in form 402 (FIG. 4). With reference to FIG. 6, any field 404 in form 402 that fails the validation process is highlighted. The initiator can then adjust the data entered into these fields, or can provide an explanation, such as in comment field 408 (FIG. 4).

After the validation process, form 402 is processed for routing. With reference to FIG. 1, in step 102, the form containing content provided by the initiator of the current iteration of the business process is received. In particular, in the present exemplary embodiment, with reference to FIG. 3, the completed form 402 (FIG. 4) is received by PRE 308 for processing. It should be noted that PRE 308 can be located in the same unit as host 306 or in a separate unit. Regardless, terminal 304 need not have access to PRE 308. It should also be noted that PRE 308 can be implemented as software, hardware, or a combination of software and hardware.

With reference to FIG. 1, in step 104, one or more key data are selected from the content in received form 402 (FIG. 4). In the present exemplary embodiment, the one or more key data correspond to one or more fields 404 of form 402. For example, the “Department” field can be selected as a key data. In one preferred embodiment, at least six key data are selected. It should be noted, however, that any number of key data can be used. It should also be noted that the number and the identity of the key data to be selected from the content of form 402 can be determined in advance.

In step 106, the one or more selected key data are compared to the content of one or more previous iterations of the business process that have been saved using any matching algorithm, such as a brute-force with partial (left, middle, right, generated key), soundex, Boyer-Moore, Knutt-Morris-Pratt, shift-or, and the like. In this example, previous iterations of the business process are previous “Expense Report” forms that have been routed prior to the current “Expense Report” being processed to be routed. With reference to FIG. 3, in the present exemplary embodiment, previous iterations of the business process are stored in database 310. Each of the previous iterations of the business process is associated with a process path, which sets out the routing of the form during the previous iteration. In this example, the process path corresponds to the manner in which the previous “Expense Report” form was routed to participants in the business process.

In one exemplary embodiment, the one or more selected key data are compared to the contents of one or more previous iterations of the business process based on the type of business process of the current iteration of the business process. Thus, in this example, because the current business process is an “Expense Report” process, the one or more key data are only compared to the content of previous iterations of “Expense Report” processes. Additionally, the one or more selected key data are compared to the content of one or more previous iterations of the business process that were initiated by the same initiator as the current iteration. This has the advantage of customizing the process of predicting a process path specific to initiators, which can increase the accuracy of the prediction.

In another exemplary embodiment, the one or more selected key data are compared to previous iterations based on the type of business process, but not based on the identity of the initiator. Thus, the one or more selected key data are compared to previous iterations initiated by any initiator rather than just the current initiator.

In this exemplary embodiment, PRE 308 a probability for the accuracy of the prediction is determined using a statistical algorithm, such as recency frequency monentary (RFM), decision tree, genetic, Naïve Baise, neural network, and the like. In particular, a statistical agent can be used to determine the number of previous iterations stored in database 310 that match (either full matches or partial matches) the one or more selected key data. A percentage is determined for the participants involved in the process path associated with the matching previous iterations. A threshold percentage can be used to determine which participants will be used in the predicted process path for the current iteration. The ordering and roles of these participants are also presented to the initiator as part of the predicted process path. The threshold percentage can be determined in advance and/or adjusted.

For example, assume that 1,000 previous iterations are found to have content that match one or more key data of a current iteration. Participant A is determined to have been involved in 900 (90 percent) of these iterations, participant B is determined to have been involved in 850 (85 percent) of these iterations, participant C is determined to have been involved in 950 (95 percent) of these iterations, and participant D is determined to have been involved in 200 (20 percent) of these iterations. Assume that the threshold percentage has been set at 80 percent (note again that the threshold percentage can be set at any percentage, and can be adjusted). Thus, participants A, B, and C are determined to be in the predicted process path for the current iteration, but not participant D. The ordering and roles of participants A, B, and C are presented to the initiator as part of the predicted process path.

In one exemplary embodiment, the participants of the business process can be limited to participants within a single enterprise. Alternatively, in another exemplary embodiment, the participants can extend across multiple enterprises. For example, a company can include preferred vendors as participants in certain business processes.

With reference again to FIG. 1, in step 108, a closest matching previous iteration of the business process is determined based on the comparison performed in step 106. In the present exemplary embodiment, a full match between the one or more selected key data and the content of the one or more previous iterations is determined, meaning that all of the selected key data match the content of a previous iteration of the business process. If a full match is not found, a partial match is determined between one or more of the selected key data and the content of the one or more previous iterations. If a partial match is not found, a most-recent, successful previous iteration is selected as the closest matching previous iteration.

For example, assume that the “Department”, Airfare Total, and Net Total (note that Net Total corresponds to the total of all the totals of all the days or all categories in FIG. 4) are selected as the key data. As noted above, in one preferred embodiment, a minimum of six key data are selected. However, for the sake of convenience and clarity, for the purposes of this example, assume that only three key data are selected.

The data in the “Department”, Airfare Total, and Net Total are then compared with the content of previous iterations. If the content of a previous iteration has a “Department” of “Marketing”, an Airfare Total of “$700.00”, and a Net Total of “$1,371.50”, then a full match has been found. The process path associated with the matching previous iteration is then identified as the predicted process path for the current iteration.

If a full match is not found, then a partial match is determined. For example, if the content of a previous iteration has a “Department” of “Marketing” and an Airfare Total of “$700.00”, but has a Net Total of “$2,000.00”, then a partial match has been found. The process path associated with the matching previous iteration is then identified as the predicted process path for the current iteration.

If a partial match is not found, then the most-recent successful previous iteration is selected as the closest matching previous iteration. For example, assume that none of the previous iterations of the business process matches any of the selected key data, then the previous iteration that was successfully executed most recently is selected as the closest matching previous iteration. In this example, the most recent “Expense Report” that was successfully routed is selected. The process path associated with the matching previous iteration of the business process is then identified as the predicted process path for the current iteration.

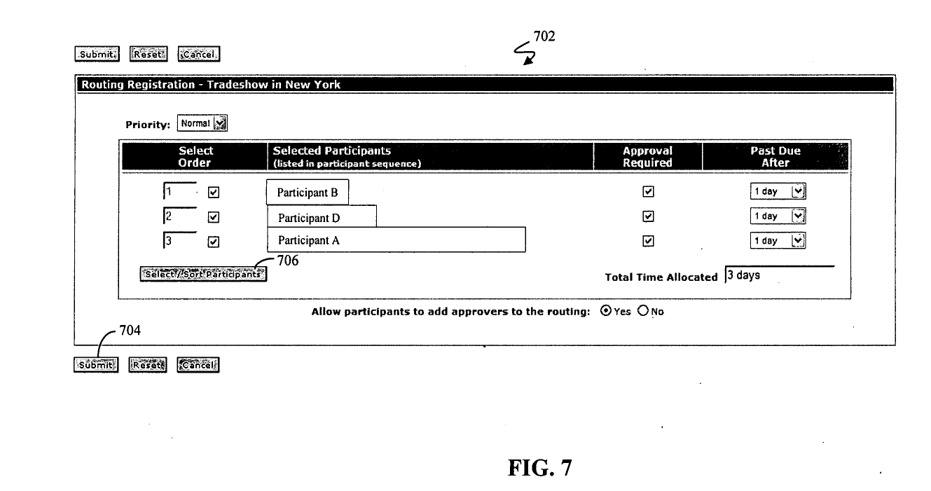

After the predicted process path has been identified, the predicted process path is presented to the initiator. With reference to FIG. 7, an exemplary process path 702 is depicted. In the present exemplary embodiment, process path 702 includes a list of one or more participants to whom the received form is to be routed as part of the current iteration of the business process. In this example, as depicted in FIG. 7, the received form is to be routed to Participants B, D, and A.

In the present exemplary embodiment, process path 702 also includes an ordering of the one or more participants. In this example, as depicted in FIG. 7, participants B, D, and A are ordered as 1, 2, and 3. Thus, the received form is to be first sent to participant B, then to D, and finally to A. It should be noted that multiple participants can be designated to be at the same ordering level. For example, if participants D and A are both ordered as 2, then the form will be sent to both participants D and A after participant B.

In the present exemplary embodiment, process path 702 also includes roles of each of the one or more participants. In this example, as depicted in FIG. 7, participants B, D, and A are assigned as approvers (note that the “Approval Required” field for each participant is checked). Thus, when participants B, D, and A receive the form, each participant will be asked to approve or deny the form. In the example depicted in FIG. 7, if a participant is not selected as an approver (for example, if the “Approval Required” field of a participant is not checked), then that participant is a copied participant. Thus, the form is only forwarded to the participant selected as a copied participant without asking the participant to approve or deny the form.

In the present exemplary embodiment, process path 702 also includes a “Past Due After” field, which specifies the amount of time provided to a participant assigned as an approver to approve or deny the form. For example, if “1 day” is specified, then participant B is given 1 day from when the form is routed to participant B to approve or deny the form. The form is then sent to participant D, who is also given 1 day to approve or deny the form. The form is then sent to participant A, who is also given 1 day to approve or deny the form.

After being presented with predicted process path 702, the initiator can then select a “Submit” button 704 to route the form in accordance with predicted path 702. In this example, the form would be first routed to participant B for approval, then to participant D for approval, and finally to participant A for approval. The current iteration of the business process is stored as a newly stored previous iteration of the business process with the predicted process path stored as the associated process path of the newly stored previous iteration of the business process.

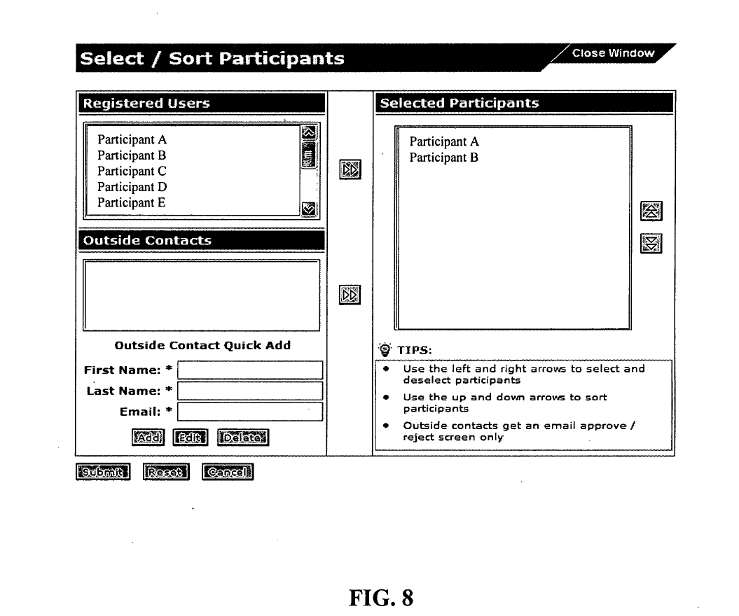

Alternatively, in the present exemplary embodiment, after being presented with predicted process path 702, the initiator can modify the predicted process path. In particular, the initiator can modify any one or more lists of the one or more participants. For example, the initiator can select “Select/Sort Participants” button 706 in predicted process path 702. With reference to FIG. 8, the initiator can then add or delete participants. With reference to FIG. 7, the initiator can also modify the ordering of the participants by changing the “Select Order” field of the participant. The role of a participant can be modified by selecting or de-selecting the “Approval Required” field for the participant. The “Past Due After” field can also be modified by the initiator.

After the modifications are made, the initiator can then select the “Submit” button 704 to route the form in accordance with the modified process path. The current iteration of the business process is stored as a newly stored previous iteration of the business process with the modified process path stored as the associated process path of the newly stored previous iteration of the business process.

Thus, in this manner, the number of previous iterations of the business process increases. As the number of previous iterations increases, the likelihood of finding a full or partial match while looking for a closest match increases. Also changes to future routings of subsequent business processes are implemented through the storing of modified process paths without having to model the business process or adjust any coded rules.

Although various exemplary embodiments have been described, it will be appreciated that various modifications and alterations may be made by those skilled in the art.

What is claimed is:

1. An automated method of predicting a process path for a business process involving participants within an enterprise and/or across enterprises, the method comprising:
a) receiving a form containing content provided by an initiator of a current iteration of the business process;
b) selecting one or more key data from the content in the received form;
c) comparing the one or more selected key data to the content of one or more previous iterations of the business process that have been stored, wherein each of the one or more previous iterations of the business process is associated with a process path;
d) determining a closest matching previous iteration of the business process based on the comparison; and
e) identifying a predicted process path for the current iteration of the business process provided by the initiator, wherein the predicted process path is the process path associated with the closest matching previous iteration of the business process.

2. The method of claim 1, wherein the form includes a plurality of fields to be completed by the initiator, and wherein the one or more key data are selected from among the plurality of fields.

3. The method of claim 2, wherein at least a minimum of six key data are selected.

4. The method of claim 2, further comprising:
after a), validating data entered in the plurality of fields by the initiator.

5. The method of claim 4, wherein validating data comprise:
comparing the data entered in the plurality of fields to predetermined policies.

6. The method of claim 1, wherein the form is one of a plurality of different types of forms, wherein each type of form is associated with a different type of business process.

7. The method of claim 6, wherein in c) the one or more selected key data are compared to the content of one or more previous iterations of the business process based on the type of business process of the current iteration of the business process.

8. The method of claim 7, wherein in c) the one or more selected key data are compared to the content of one or more previous iterations of the business process that is the same type of business process as the current iteration of the business process.

9. The method of claim 7, wherein in c) the one or more selected key data are compared to the content of one or more previous iterations of the business process based on the initiator's identity.

10. The method of claim 9, wherein the comparison is performed using a statistical algorithm.

11. The method of claim 9, wherein in c) the one or more selected key data are compared to the content of one or more previous iterations of the business process initiated by the same initiator as the current iteration of the business process.

12. The method of claim 1, wherein the one or more previous iterations of the business process are stored in a database.

13. The method of claim 1, wherein determining a closest matching previous iteration of the business process comprises:
determining whether there is a full match between one or more selected key data and the content of one or more previous iterations of the business process;
if a full match is not found, determining whether there is a partial match between one or more selected key data and the content of one or more previous iterations of the business process; and
if a partial match is not found, selecting a most-recent successful previous iteration as the closest matching previous iteration.

14. The method of claim 1, wherein the predicted process path includes participants of the business process within a single enterprise.

15. The method of claim 1, wherein the predicted process path includes participants of the business process extending among two or more enterprises.

16. The method of claim 1, further comprising:
routing the current iteration of the business process in accordance with the predicted process path; and
storing the current iteration of the business process as a newly stored previous iteration of the business process with the predicted process path stored as the associated process path of the newly stored previous iteration of the business process.

17. The method of claim 1, further comprising:
presenting the predicted process path to the initiator.

18. The method of claim 17, wherein the predicted process path presented to the initiator comprises:
a list of one or more participants;
an ordering of the one or more participants; and
roles of each of the one or more participants.

19. The method of claim 18, wherein the roles comprise:
approvers, wherein a participant assigned as an approver participant decides whether to approve or deny the form; and
copied, wherein a participant assigned as a copied participant only receives a copy of the form.

20. The method of claim 18, further comprising:
receiving modifications by the initiator to any one or more of the list of one or more participants, the ordering of the one or more participants, and the roles of each of the one or more participants to generate a modified process path.

21. The method of claim 20, further comprising:
routing the current iteration of the business process in accordance with the modified process path; and
storing the current iteration of the business process as a newly stored previous iteration of the business process with the modified process path stored as the associated process path of the newly stored previous iteration of the business process.

22. An automated method of predicting a process path for a business process involving participants within an enterprise and/or across enterprises, the method comprising:
a) receiving a form containing content provided by an initiator of a current iteration of the business process;
b) selecting one or more key data from the content in the received form;
c) comparing the one or more selected key data to the content of one or more previous iterations of the business process, wherein the one or more previous iterations of the business process were previously initiated by the initiator of the current iteration of the business process, wherein each of the one or more previous iterations of the business process is associated with a process path;
d) determining a closest matching previous iteration of the business process based on the comparison; and
e) identifying a predicted process path for the current iteration of the business process provided by the initiator, wherein the predicted process path is the process path associated with the closest matching previous iteration of the business process.

23. An automated method of determining a predicted process path for a business process involving participants within an enterprise and/or across enterprises, the method comprising:
a) sending to a predictive routing engine a form containing content provided by an initiator of a current iteration of the business process; and
b) receiving from the predictive routing engine a predicted process path for the current iteration of the business process, wherein the predicted process path was determined by:
i) selecting one or more key data from the content in the received form;
ii) comparing the one or more selected key data to the content of one or more previous iterations of the business process that have been stored, wherein each of the one or more previous iterations of the business process is associated with a process path;
iii) determining a closest matching previous iteration of the business process based on the comparison; and
iv) identifying a predicted process path for the current iteration of the business process provided by the initiator, wherein the predicted process path is the process path associated with the closest matching previous iteration of the business process.

24. A system to predict a process path for a business process involving participants within an enterprise and/or across enterprises, the system comprising:
a database having one or more previous iterations of the business process, wherein each of the one or more previous iterations of the business process is associated with a process path; and
a predictive routing engine configured to:
a) receive a form containing content provided by an initiator of a current iteration of the business process;
b) select one or more key data from the content in the received form;
c) compare the one or more selected key data to the content of the one or more previous iterations of the business process stored in the database;
d) determine a closest matching previous iteration of the business process based on the comparison; and
e) identify a predicted process path for the current iteration of the business process provided by the initiator, wherein the predicted process path is the process path associated with the closest matching previous iteration of the business process.

25. A computer-readable storage medium having computer-executable instructions for causing a computer to determine a prediction process path for a business process involving participants within an enterprise and/or across enterprises, comprising instructions for:
a) receiving a form containing content provided by an initiator of a current iteration of the business process;
b) selecting one or more key data from the content in the received form;
c) comparing the one or more selected key data to the content of one or more previous iterations of the business process that have been stored, wherein each of the one or more previous iterations of the business process is associated with a process path;
d) determining a closest matching previous iteration of the business process based on the comparison; and
e) identifying a predicted process path for the current iteration of the business process provided by the initiator, wherein the predicted process path is the process path associated with the closest matching previous iteration of the business process.
